(19) United States
(12) Patent Application Publication
(10) Pub. No.: US 2019/0050815 A1
(43) Pub. Date: Feb. 14, 2019

(54) INTERNSHIP MANAGEMENT PLATFORM

(71) Applicant: Big Picture Learning, Providence, RI (US)

(72) Inventors: David N. BERG, Bainbridge Island, WA (US); Andrew Frishman, Cambridge, MA (US)

(21) Appl. No.: 16/016,225

(22) Filed: Jun. 22, 2018

Related U.S. Application Data
(60) Provisional application No. 62/543,224, filed on Aug. 9, 2017.

(51) Int. Cl. G06Q 10/10; G06F 17/30

(52) U.S. Cl. CPC G06Q 10/1053; G06F 17/30864; G06Q 10/1093

(57) ABSTRACT

Methods and apparatus for an internship management platform. A web server includes a processor, a memory, and a database, the memory including an operating system and a main internship management module, the main internship management module

### CROSS REFERENCE TO RELATED APPLICATIONS

This application claims benefit from U.S. Provisional Patent Application Ser. No. 62/543,224, filed Aug. 9, 2017, which is incorporated by reference in its entirety.

### STATEMENT REGARDING GOVERNMENT INTEREST

None.

### BACKGROUND OF THE INVENTION

The present invention relates generally to management systems, and more particularly to an internship management platform.

In general, an internship is an opportunity that employers offer to students interested in gaining work experience in particular industries. Internships offer students a hands-on opportunity to work in their desired field. They can learn how their course of study applies to the real world and build a valuable experience that makes them stronger candidates for jobs after graduation. Moreover, an internship can be an excellent way to “try out a certain career.”

### SUMMARY OF THE INVENTION

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

The present invention provides methods for an internship management platform.

In general, in one aspect, the invention features a system including a mobile device, the mobile device including at least a processor, a memory and a display, the memory including an operating system and an internship management app, a network of interconnected computer systems, the mobile device communicatively linked to the network of interconnected computer systems, and a web server, the web server connected to the network of interconnected computer systems, the web server including at least a processor, a memory and a database, the memory including an operating system and a main internship management module, the internship management app interacting with the main internship management module.

In another aspect, the invention features a web server including a processor, a memory, and a database, the memory including an operating system and a main internship management module, the main internship management module communicatively linked to a mobile device having an internship management app.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

These and other features, aspects, and advantages of the present invention will become better understood with reference to the following description, appended claims, and accompanying drawings where:

FIG. 1 is a block diagram of an exemplary internship management system.

FIG. 2 is a block diagram of a main internship management module.

FIG. 3 is a flow diagram.

### DETAILED DESCRIPTION

The subject innovation is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

The following terms may be useful in understanding the present invention.

Internship Coordinator (IC): An adult who curates internship database and approves student requests.

Opportunity: Any potential or actual educational experience that a student can have through direct, real world connection with a mentor. (On or off campus.)

Internship: This is a place-based, or work-based learning experience.

Turning now to the invention, the internship management platform of the present invention is an all-in-one turnkey computerized method that enables users, e.g., students, to search for internships based on their interest. Users can request to pursue opportunities that are of interest to them. They can then pursue the opportunity and secure an internship. Once a user has an internship, the internship management platform of the present invention can track attendance. Moreover, the entity that provides the internship can use the internship management platform of the present invention to coordinate compliance and oversight.

More specifically, in one implementation, the internship management platform of the present invention is a cloud-based web and mobile (iOS®/Android®) app that enables schools and students to request to pursue internships, suggest internships to be added to a school's dataset and then document internship attendance. The internship management platform of the present invention includes the educator in the internship process by enabling them to approve student requests to pursue internships as well as monitor progress, approve and document the start and end of an internship.

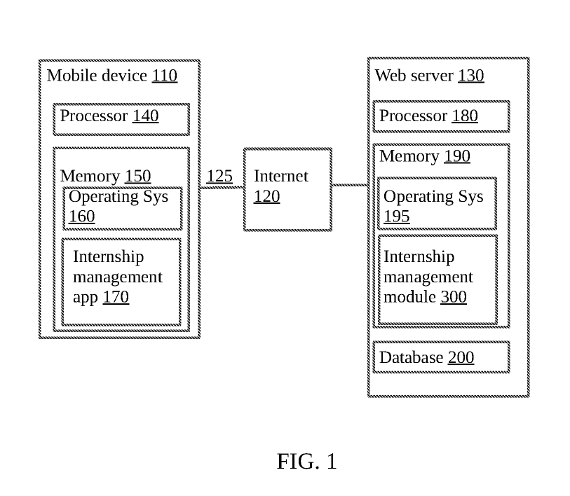

As shown in FIG. 1, an exemplary internship management platform 100 includes a mobile device 110 communicatively linked to a network of interconnected computer systems (e.g., the Internet) 120. The link 125 between the mobile device 110 and Internet 120 can be wired or wireless. The Internet 120 includes at least a web server 130.

The mobile device 110 includes at least a processor 140, a memory 150 and a display (not shown). The memory 150 includes an operating system 160, such as, for example, Android® or iOS®, and an internship management application (“app”) 170. The web server 130 includes at least a processor 180, a memory 190 and a database 200. The memory 190 includes an operating system (not shown) and a main internship management module 300. In embodiments, the internship management app 170 residing in the mobile device 110 interacts with the main internship management module 300 residing in the web server 130. Although only one web server 130 is shown in the Internet 120, it may be linked to one or more other web servers (not shown).

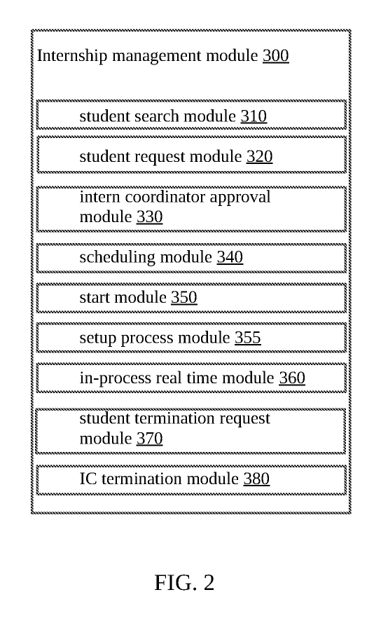

As shown in FIG. 2, the main internship management module 300 includes one or more modules. For example, the main internship management module 300 may include a student search module 310, a student request module 320, an intern coordinator (IC) approval module 330, a scheduling module 340, a start module 350, a setup process module 355, an in-process real time module 360, a student termination request module 370 and an IC termination module 380. In other implementations, more or less modules may be included.

The student search module 310 automates a process in which students can search for internships based on their interests. If they do not find an internship that they are interested in, student search module 310 enables them to suggest sites for the school to add.

The student request module 320 automates a process in which, when the student finds a site they are interested in, they can add them to their wish list or request to pursue the site. The wish list and/or request to pursue is saved to the database 200.

The intern coordinator (IC) approval module 330 automates a process in which, if the internship coordinator (IC) feels it will be a good fit, they can approve the request to pursue the site received from the student request module 320. The IC approval module 330 assign assigns a date when the request will expire. In addition, the IC approval module 330 may deny a student's request if the student does not meet specific internship requirements.

The scheduling module 340 automates a process for the student, in conjunction with the IC, to try to land the internship. The student may use the scheduling module 340 to send a resume/LinkedIn®, and attempt to schedule an informational interview or a shadow day.

The start module 350 automates a process of coordinating a start date for the student to begin the internship.

The setup process module 355 automates a process of approving the student to start the internship, setting goals and a schedule.

The in-process real time module 360 automates a process of receiving weekly summary reports for the student during the internship.

The student termination request module 370 automates a process of receiving a request from the student to end the internship.

The IC termination module 380 automates a process of the IC terminating the internship and making it available to other students.

In summary, the user interacts with the internship management module 300 using the internship management app 170. More specifically, the internship management app 170 displays one or more graphical user interfaces (GUIs) generated by the modules contained with the internship management module 300. The user can input data and receive data through the one or more GUIs. Data inputted by the user is transmitted to the internship management module 300, processed in conjunction with the database and external reviewers, and the results (or further input requests) sent back to the internship management app 170.

In a preferred embodiment, each of the modules 310, 320, 330, 340, 350, 355, 360, 370, 380 generates a graphical user interface (GUI) for the display in the mobile device 110.

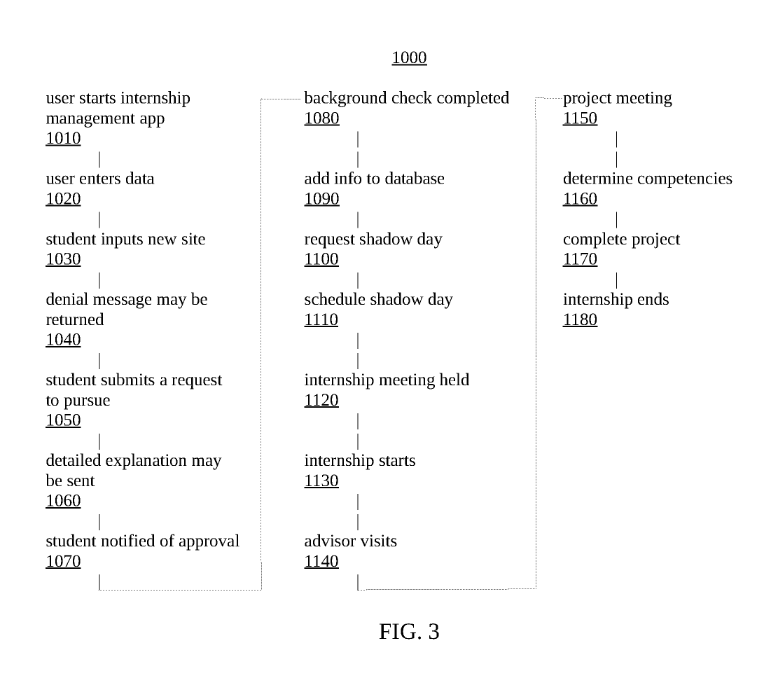

As shown in FIG. 3, a process 1000 includes a user. e.g., a student, starting (1010) the internship management app and entering (1020) data to begin a search for potential shadow days or an internship site. If the inputted data fails to make a match in the database, the student may input (1030) a new site and request site approval. If the site is not approved, a message containing an explanation of the denial is returned (1040) to the student and his/her advisor, with possible alternatives.

If the search matches a site, the student submits (1050) a request to pursue. If the request is denied, the detailed explanation is sent (1060) to the student and his/her advisor, along with possible alternatives.

If the request is approved, the process notifies (1070) the student and the advisor that the student can pursue. The process notifies (1080) both if a background check is up to date. All the information is then added (1090) to the database so it will remain updated.

The student may use the app to request (1100) a shadow day or interview. A shadow day is scheduled (1110) and after both the advisor and student submit a reflection and level of interest in the opportunity. If the student interest remains high, an internship meeting is held (1120) with the advisor and internship mentor wherein internship hours, expectations and academic requirements are established.

The internship is started (1130) during which the student completes a daily attendance log and journal. The advisor may randomly visit (1140) with the student during this internship period. In one embodiment, after 2-4 weeks, the advisor, student and mentor have a project setup meeting where they discuss (1150) a real-world internship project that aligns with site needs and student interests. The advisor determines (1160) academic competencies that can be met through project work. The student completes (1170) the project proposal for the advisor and mentor approval and the project work is shown at student exhibition. Finally, the internship ends (1180).

Using the internship management platform described above, students can search for internships based on the industry type of the business or the industry type of the opportunity (e.g., an engineer who works at a hospital). Students can also search based on keywords, on mentor and on location. Search results are mapped and can be filtered by opportunity status (e.g., available, being pursued, filled).

Students can search for internships based on the type of opportunity and/or the type of business. Students can review the location of the internship, details about the mentor and see past students who have interned at this opportunity. They can then request to pursue this opportunity.

The Internship Coordinator can approve or deny the student request to pursue. The student receives a notification. If the request is approved, the student has a set amount of time to pursue the request and try to turn it into an internship. After this time, the opportunity becomes available again. If the request is denied, the student receives a notification and the opportunity becomes available again.

If a student does not find an opportunity that they are interested in, they can suggest opportunities. In this way they can leverage their networking power to find other opportunities for the school.

The internship coordinator must approve or deny the suggested opportunity. If the opportunity is approved, the internship coordinator can add additional information and publish the opportunity to the school's dataset.

Internship Coordinators can define compliance documents for active internships. Internship Coordinators and Advisors can upload documents when a new internship starts. Internship Coordinators can review and approve uploaded documents. The platform notifies the Internship Coordinator when compliance documents are about to expire.

The student can utilize localization technologies on their Android or iOS device to check in and out of their attendance. The reporting includes map and coordinates as well as the location of the opportunity. Upon completion of a cycle of check-in and check-out, the opportunity mentor receives an html email asking him/her to verify the student attendance.

The advisor can observe if attendance is in alignment with the agreed-upon internship times. The platform can provide custom reports for integration with a Student Information System(s).

The student requests to start and end internships. Advisors complete on boarding workflow to approve and begin an internship. The advisor completes an internship end workflow when a student requests to end an internship.

It would be appreciated by those skilled in the art that various changes and modifications can be made to the illustrated embodiments without departing from the spirit of the present invention. All such modifications and changes are intended to be within the scope of the present invention except as limited by the scope of the appended claims.

What is claimed is:

1. A system comprising:
a mobile device, the mobile device including at least a processor, a memory and a display, the memory comprising an operating system and an internship management app;
a network of interconnected computer systems, the mobile device communicatively linked to the network of interconnected computer systems; and
a web server, the web server connected to the network of interconnected computer systems, the web server including at least a processor, a memory and a database, the memory comprising an operating system and a main internship management module, the internship management app interacting with the main internship management module.

2. The system of claim 1 wherein the main internship management module comprises a plurality of modules.

3. The system of claim 2 wherein the plurality of modules comprises:
a student search module;
a student request module;
an intern coordinator (IC) approval module;
a scheduling module;
a start module;
a setup process module;
an in-process real time module;
a student termination request module; and
an IC termination module.

4. The system of claim 3 wherein the student search module comprises a process in which students can search for internships based on their interests.

5. The system of claim 3 wherein the student request module module comprises a process in which, when a student finds a site they are interested in, they can add them to their wish list or request to pursue the site.

6. The system of claim 3 wherein the intern coordinator (IC) approval module the scheduling module module comprises a process in which, if an internship coordinator (IC) feels it will be a good fit, they can approve a request to pursue a site.

7. The system of claim 3 wherein the start module module comprises a process for a student, in conjunction with an IC, to try to land an internship.

8. The system of claim 3 wherein the setup process module module comprises a process of coordinating a start date for a student to begin an internship.

9. The system of claim 3 wherein the in-process real time module module comprises a process of receiving weekly summary reports for a student during an internship.

10. The system of claim 3 wherein the student termination request module the IC termination module module comprises a process of receiving a request from a student to end an internship.

11. A web server comprising:
a processor;
a memory; and
a database, the memory comprising an operating system and a main internship management module, the main internship management module communicatively linked to a mobile device having an internship management app.

12. The system of claim 11 wherein the main internship management module comprises a plurality of modules.

13. The system of claim 12 wherein the plurality of modules comprises:
a student search module;
a student request module;
an intern coordinator (IC) approval module;
a scheduling module;
a start module;
a setup process module;
an in-process real time module;
a student termination request module; and
an IC termination module.

14. The system of claim 13 wherein the student search module comprises a process in which students can search for internships based on their interests.

15. The system of claim 13 wherein the student request module module comprises a process in which, when a student finds a site they are interested in, they can add them to their wish list or request to pursue the site.

16. The system of claim 13 wherein the intern coordinator (IC) approval module the scheduling module module comprises a process in which, if an internship coordinator (IC) feels it will be a good fit, they can approve a request to pursue a site.

17. The system of claim 13 wherein the start module module comprises a process for a student, in conjunction with an IC, to try to land an internship.

18. The system of claim 13 wherein the setup process module module comprises a process of coordinating a start date for a student to begin an internship.

19. The system of claim 13 wherein the in-process real time module module comprises a process of receiving weekly summary reports for a student during an internship.

20. The system of claim 13 wherein the student termination request module the IC termination module module comprises a process of receiving a request from a student to end an internship.
